(19) United States
(12) Patent Application Publication
(10) Pub. No.: US 2018/0149569 A1
(43) Pub. Date: May 31, 2018

(54) COUPLING DEVICE FOR THERMOGRAVIMETRIC ANALYSIS

(71) Applicant: GLAS TRÖSCH HOLDING AG, Buochs (CH)

(72) Inventor: Andreas SYNOWCZYK, Zofingen (CH)

(73) Assignee: GLAS TRÖSCH HOLDING AG, Buochs (CH)

(21) Appl. No.: 15/574,982

(22) PCT Filed: Apr. 20, 2016
(86) PCT No.: PCT/CH2016/000069

§ 371 Date: Nov. 17, 2017

(30) Foreign Application Priority Data
May 20, 2015 (CH) 697/15

(51) Int. Cl. G01N 5/04; G01N 1/44; G01K 1/04; G01N 1/40

(52) U.S. Cl. CPC G01N 5/04; G01N 2001/4033; G01K 1/045; G01N 1/44

(57) ABSTRACT

The invention relates to a coupling device for thermogravimetric analysis for coupling a thermogravimetric analysis with a spectroscopic analysis, comprising a housing with a connecting element by means of which said housing can be connected in a gas-tight and detachable manner to a sample chamber of a device for gravimetric analysis. The coupling device comprises at least two flange bushings or at least two adsorption elements which are detachably connected to the coupling device and comprise, on a first side, a condensation surface or an adsorption body for gaseous components. A screen is arranged on the coupling device such that it lies between the at least two flange bushings or the at least two adsorption elements and the sample chamber, wherein the screen has at least one opening. A changing device allows the at least two flange bushings, the at least two adsorption elements or the screen to move in such a way that the condensation surface of at least one flange bushing or an adsorption body of at least one adsorption element lies opposite the at least one opening. A cooling device allows the condensation surfaces of the at least two flange bushings to be cooled.

### TECHNICAL FIELD

The invention relates to a coupling device for thermogravimetric analysis, in particular of polymer materials, which enables a separation of the material fractions obtained by the thermogravimetric separation and the subsequent spectroscopic analysis thereof.

### PRIOR ART

In plastic production, polymer mixtures (blends) and copolymers are used particularly commonly. In such plastics, the polymer matrix is composed of at least two polymer substances. Furthermore, additives, which confer a certain functionality to the plastic, can be used. Such additives are, for example, plasticizers, bonding agents, stabilizers, dyes, pigments, biogenic active substances such as fungicides and auxiliary materials for improving the processing rheology. Moreover, fillers such as chalk or reinforcing materials such as glass fibers can also be used.

The individual components of a polymer mixture or of a copolymer can be examined by means of thermogravimetric analysis. In the process, a sample of a polymer material in a crucible made of a thermally stable material is heated by means of an oven. During the analysis, the sample chamber moreover can be flushed with a gas such as nitrogen, for example. The crucible is coupled to a microscale which records weight changes of the polymer material during the heating process. Depending on the temperature and the gas feed into the sample chamber of the thermogravimetric analysis device, a polymer material reacts by outgassing volatile components (desorption), with cleavage of the polymer matrix by pyrolysis (under nitrogen) and oxidation (under oxygen) to form degradation products. This is recorded by the microscale as a weight loss of the polymer material.

The release of volatile components from a polymer material occurs with increasing temperature depending on the thermal stability of the components. Thermally stable components do not undergo a chemical cleavage reaction during desorption.

If a component is present in a polymer material with proportions by weight from 5% by weight, a clear weight loss results in the course of the thermogravimetric analysis.

For the analysis of the components outgassed or cleaved from the polymer product, said components can be transferred by means of a coupling device, usually a heated transfer line, to a mass spectrometer or an infrared spectrometer.

In the known methods for coupling between thermogravimetric analysis device and spectrometer, components which have a high evaporation temperature can condense, in spite of the heating of the transfer line, on its inner wall and thus can hardly be acquired spectroscopically. As a result, the analysis performance of current coupling systems is restricted only to those components of a polymer product that have an evaporation temperature which is below the maximum heating temperature of the transfer line, which is usually up to 300° C. Furthermore, no spatially or temporally separated spectroscopic analysis is possible.

### DESCRIPTION OF THE INVENTION

The aim of the invention is to produce a coupling device belonging to the technical field mentioned at the start, which makes it possible to spectroscopically determine all the components of a polymer material that arise in a thermogravimetric analysis. In particular, by means of the present invention, a particularly precise and complete analysis of a polymer material in a thermogravimetric analysis in a temperature range from 25° C. to 960° C. should be made possible.

The solution for achieving the aim is defined by the features of Claim 1. According to the invention, the coupling device for thermogravimetric analysis comprises a housing with a connecting element by means of which the housing can be connected in a gas-tight and detachable manner to a sample chamber of a device for thermogravimetric analysis. Furthermore, the coupling device comprises at least two flange bushings or two adsorption elements which are detachably connected to the coupling device and which comprise, on a first side, a condensation surface or an adsorption body for gaseous components, as well as a screen which is arranged in such a manner that said screen lies between the at least two flange bushings or the at least two adsorption elements and the sample chamber, wherein the screen has at least one opening. Furthermore, the coupling device comprises a changing device by means of which the at least two flange bushings, the at least two adsorption elements or the screen can be moved in such a manner that the condensation surface of at least one flange bushing or the adsorption body of at least one adsorption element lies opposite the at least one opening. In addition, a cooling device is present, which allows the condensation surfaces of the at least two flange bushings or the adsorption bodies of the at least two adsorption elements to be cooled.

By cooling the condensation surfaces or the adsorption bodies, it is ensured that components that escape into the gas phase due to the heating or degradation products of a polymer material to be analyzed are deposited on the condensation surfaces as coating or in the adsorption bodies in liquid or solid form (sublimates). Since the flange bushings as well as the adsorption elements can be removed from the coupling device, the components and degradation products deposited on the condensation surfaces or adsorbed in the adsorption elements can subsequently be further examined separately, for example, by spectroscopy. Since no transfer line is needed, the spectroscopic analysis can be carried out both spatially and also temporally separately from thermogravimetric analysis. By means of the coupling device according to the invention, it is also possible to spectroscopically determine all the organic components, including those with a high evaporation point, of a polymer material to be analyzed. In addition, due to the movement of the flange bushings, of the adsorption elements or of the screen, it is achieved that a different component of the polymer material is deposited on the condensation surface of each flange bushing or in the adsorption body of each adsorption element. As a result, each component can be examined spectroscopically individually, which simplifies the identification of the individual components. In addition, it is possible to dispense with an additional separation of the volatile components, for example, via a gas chromatograph.

However, if a mixture of two or more components or degradation products condense on the condensation surfaces or in the adsorption bodies, for example, a mixture of two or more components or degradation products which have identical or very close together evaporation points, an additional separation by liquid chromatography or gas chromatography can occur, before a spectroscopic analysis is carried out. Here, the individual components or degradation products of the mixture can be separated and subsequently analyzed spectroscopically individually. The mixture can also be transferred to the chromatography by dissolution of the condensate from the condensation surfaces or from the adsorption bodies by means of a solvent or by thermodesorption.

A device for thermogravimetric analysis usually has a sample chamber in which the corresponding crucible for receiving a sample is located. This crucible is connected to a microscale which can record weight losses of the sample. Usually, scales that work according to the principle of electromagnetic compensation are used. Furthermore, such a device comprises an oven which generates the most homogeneous temperature field possible in the area of the crucible. The housing of the coupling device according to the invention is shaped and dimensioned such that it can be connected in a gas-tight manner via a connecting element to the sample chamber. Preferably, the coupling device is connected to an upper wall of the sample chamber. However, the coupling device can alternatively also be attached to a side wall of the sample chamber. The only important factor is that a fluidic connection exists between the sample chamber and the at least one opening of the screen.

Preferably, in a coupling device connected to a sample chamber, the at least two flange bushings or the at least two adsorption elements can be connected and disconnected again from outside of the sample chamber by means of the coupling device.

Preferably, the coupling device has more than two flange bushings or adsorption elements. The flange bushings or adsorption elements here can be arranged linearly one after the other. However, the flange bushings or adsorption elements are preferably arranged in the shape of a circle.

Accordingly, the changing unit can bring about a linear shifting of the flange bushings, of the adsorption elements or of the screen. Preferably, the changing device is designed to rotate the flange bushings, the adsorption elements or the screen.

The changing device is preferably driven via a motor, so that an automatic movement of the flange bushings or of the adsorption elements can occur. However, alternatively it can also be provided that the changing device is operated manually by a user, for example, via a crank or the like.

Preferably, the coupling device is designed such that, as selected, either flange bushings or adsorption elements can be detachably connected to said coupling device. As a result, the same coupling device can be used for different analysis processes downstream of the thermogravimetric analysis. In particular, the flange bushings as well as the adsorption elements here have the same dimensions and identical fastening means by means of which they can be detachably connected to the coupling device.

The screen is preferably arranged such that it is a very short distance from the condensation surfaces of the at least two flange bushings or the adsorption bodies of the at least two adsorption elements, in particular 1 mm or less. As a result, deposition of a volatile component on the condensation surface of a flange bushing or in the adsorption body of an adsorption element located behind the screen is reliably prevented.

The at least one opening of the screen is preferably shaped and dimensioned such that it corresponds substantially to the shape and size of the condensation surface of the at least two flange bushings or of a side of the adsorption body, which protrudes toward the screen, of the at least two adsorption elements.

The condensation surfaces are preferably of flat design. However, the condensation surfaces can alternatively also be designed with a concave or convex curvature.

Preferably, the cooling device is connected in a thermally conductive manner to the at least two flange bushings or the at least two adsorption elements. Since the flange bushings or adsorption elements that do not lie opposite the opening of the screen are also cooled, it is possible to prevent components previously deposited on the condensation surface or on the adsorption body from being evaporated again.

The housing of the coupling device consists of a stainless steel on the side of its walls directed towards the sample chamber, while the outward-directed sides of the walls are made of a ceramic material.

The present invention is described as an example in reference to the analysis of a polymer material. However, it should be clear to a person skilled in the art that the application of the present invention is not limited to the analysis of polymer material, but can instead also be used advantageously to analyze other materials such as alloys or natural substances, for example.

The at least two flange bushings preferably have a cylindrical flange arranged at the first end as well as a cylindrical bushing arranged at the second end opposite the first end, which are detachably connected to one another.

As a result, it is possible to detach the flange, on which the condensation surface is also located, from the bushing, in order to provide said flange subsequently to a spectroscopic examination. The flange alone is smaller and easier to handle for a spectroscopic analysis than the whole flange bushing. In addition, for a re-use of the coupling device, it is possible to replace only the flange of the at least two flange bushings, which helps lower the material consumption and thus the operating costs.

The connection between the flange and the bushing is preferably implemented as a threaded connection. Alternatively, the flange and bushing can also be connected together via a plug-in connection.

Preferably, the cylindrical bushing has a threading by means of which it can be connected detachably in bores of the changing device. Via a threaded connection, the at least two flange bushings can be detachably connected rapidly and simply and yet in a very stable manner to the changing device.

Alternatively, the cylindrical bushing can also be detachably connected to an opening of the changing device via a conical plug-in connection.

Preferably, the cylindrical bushing is produced from copper and the cylindrical flange from stainless steel. Since copper has a relatively high heat conductivity, an optimal thermally conductive connection with the cooling device can be achieved. Moreover, the condensation surfaces of the at least two flange bushings preferably consist of stainless steel. For a subsequent analysis of the evaporated components deposited on the condensation surface by means of infrared spectroscopy, in particular by means of the attenuated total reflection infrared spectroscopy (ATR IR), stainless steel has a nearly 100% reflectivity at the wave numbers of 600 to 4000 1/cm. Therefore, in the wave number range conventionally used, the condensation surface does not have transmissivity or adsorptivity.

Preferably, the at least two adsorption elements include a base by means of which the adsorption elements can be detachably connected to the changing device. The adsorption body, which consists of an adsorbent material, is connected to the base.

The adsorption body is preferably shaped as cylindrical. The adsorbent material is preferably arranged within a small tube which surrounds the adsorbent material on the lateral side. In a particular embodiment, the adsorption body is connected detachably to the base or connected detachably to the base and removable from the small tube. As a result, the adsorption body can be separated from the base for additional analyses, or the base can be fitted with a new adsorption body for the performance of an additional thermogravimetric analysis.

Preferably, the adsorbent material comprises active charcoal. However, a zeolite or silica can also be used alternatively as adsorbent material.

Preferably, the cooling device is a Peltier element. By means of a Peltier element, a sufficiently high cooling power can be reached, so that the condensation surfaces of the at least two flange bushings are cooled sufficiently so that evaporated components are deposited on said condensation surfaces. Preferably, the condensation surfaces are cooled during a thermogravimetric analysis with the coupling device according to the invention to approximately 15° C.

Preferably, the Peltier element has a power of at least 120 watts.

The at least two flange bushings or the at least two adsorption elements are preferably coupled thermally to the Peltier element.

Preferably, the at least two flange bushings or the at least two adsorption elements have a gas passage line, by means of which gas located in the sample chamber can be suctioned, in particular via at least one peristaltic pump.

Usually, in thermogravimetric analysis, the sample chamber is supplied with a gas, so that the sample to be analyzed does not react with the oxygen present in the ambient air. Through the gas passage line, the gas located in the sample chamber, in which the evaporated components of the polymer material to be analyzed are also located, can then be suctioned from the sample chamber. Preferably, during the analysis, gas is preferably suctioned respectively only at the flange bushing or the adsorption element that lies opposite the opening of the screen. At the same time, at the same flow speed, additional gas is conveyed into the sample chamber. As a result, a gas flow is generated toward the flange bushing that lies opposite the opening or the adsorption element, so that the evaporated components are conveyed towards said opening. As a result, an increased deposition of the evaporated components on the condensation surface or the adsorption body can be achieved.

The gas passage line of each flange bushing or in each adsorption element is preferably connected to a separate pump. However, alternatively, only a single pump can also be used, which can be connected selectively via feed lines and valves to the gas passage lines of the individual flange bushings or the individual adsorption elements. Preferably, a peristaltic pump is used, since with said pump, a continuous or very precisely settable gas flow can be generated. However, alternatively, another pump that is suitable for conveying gas, for example, a piston pump, can also be used.

Between the gas passage line and the pump, a filter is preferably arranged, in order to filter from the gas flow possible liquid drops and evaporated components which have not deposited on the condensation surfaces.

Preferably, the connecting element is designed as threaded. As a result, the coupling device according to the invention can be connected particularly simply and rapidly to the sample chamber. In addition, in an appropriate design of the threading, a gas-tight connection is possible.

Preferably, the coupling device is equipped in such a way that the flange bushings or the adsorption elements are can be automatically detached from the coupling device by a sample robot and transferred to a spectrometer. Thus, the entire analysis process consisting of thermogravimetry and spectroscopy can occur automatically.

The present application furthermore relates to a method for analyzing a polymer material. In a first step, the polymer material to be analyzed is placed in a sample crucible of a device for thermogravimetric analysis. Then, a coupling device according to the invention is connected to a sample chamber of the device for thermogravimetric analysis. Subsequently, by means of the changing unit, the screen, the least two adsorption elements or the at least two flange bushings is/are moved in such a manner that the first end of a first flange bushing of the at least two flange bushings or the adsorption body of a first adsorption element of the at least two adsorption elements lies opposite the opening of the screen. Then, the sample crucible is heated, and the screen, the at least two adsorption elements or the at least two flange bushings is/are moved by the changing device in such a manner that, for each outgassed component of the polymer material, the first end of a different flange bushing or the adsorption body of a different adsorption element lies opposite the opening. Subsequently, the at least two flange bushings or the at least two adsorption elements are removed from the coupling device, and the components of the polymer material deposited on the condensation surfaces or on the adsorption bodies are analyzed spectroscopically, in particular by means of infrared spectroscopy or mass spectroscopy.

Preferably, the analysis of the components of the polymer material deposited on the condensation surfaces occurs by means of attenuated total reflection infrared spectroscopy (ATR IR).

Preferably, before the spectroscopic analysis, the cylindrical flanges are separated from the cylindrical bushings. As a result, it is then possible to supply the cylindrical flanges to further spectroscopic analysis.

Additional advantageous embodiments and feature combinations of the invention result from the following detailed description and the claims as a whole.

### BRIEF DESCRIPTION OF THE DRAWINGS

The drawings used for explaining the embodiment examples show:

FIG. 1 a diagrammatic representation of a coupling device according to the invention, which is connected to a device for thermogravimetric analysis, in cross section;

FIG. 2 a diagrammatic view of the coupling device from below;

FIG. 3 a detailed side view of a flange bushing;

FIG. 4 the coupling device according to FIG. 1 with adsorption elements instead of flange bushings.

In principle, in the figures, identical parts are marked with identical reference numerals.

### WAYS OF CARRYING OUT THE INVENTION

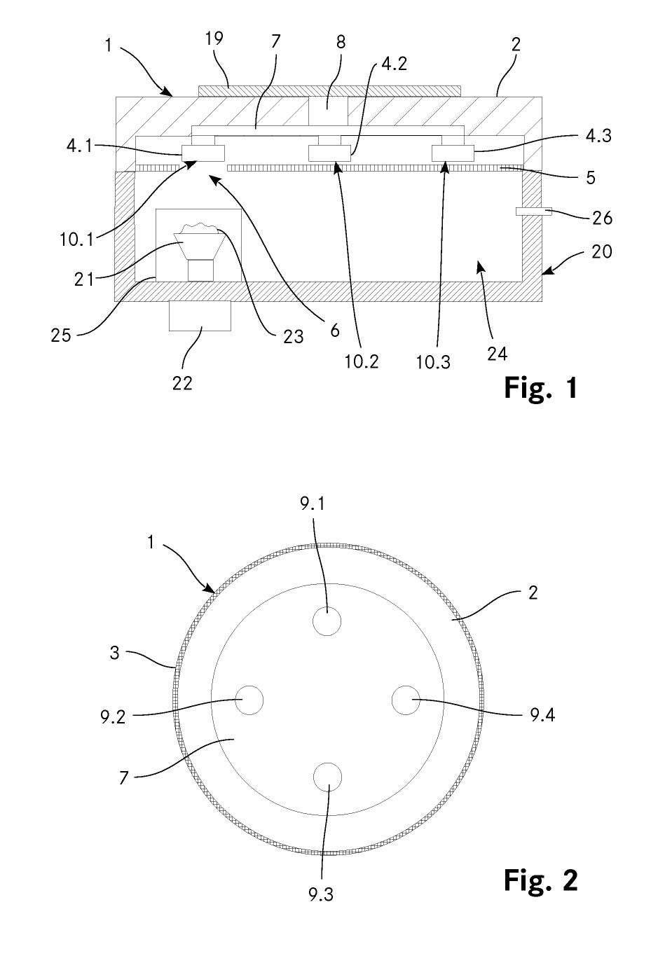

FIG. 1 shows a diagrammatic representation of a coupling device 1 according to the invention, which is connected to a device for thermogravimetric analysis 20, in cross section. The coupling device 1 has a housing 2 which is connected via a connecting element (not shown), for example, via a threading, to the device for thermogravimetric analysis 20. The coupling device has four flange bushings 4.1, 4.2, 4.3, 4.4, in the example shown. Due to the perspective of the representation, the fourth flange bushing 4.4 is not visible, since it is behind the second flange bushing 4.2 in the viewing direction. The four flange bushings 4.1, 4.2, 4.3, 4.4 are connected via a changing device 7 to the housing 2 of the coupling device 2 and each has a condensation surface 10.1, 10.2, 10.3, 10.4. Furthermore, the coupling device 1 comprises a screen 5 which has an opening 6. The screen 5 is arranged in such a manner that, in coupling device 1 connected to the device for thermogravimetric analysis 20, it is located between the condensation surfaces 10.1, 10.2, 10.3, 10.4 of the flange bushings 4.1, 4.2, 4.3, 4.4 and a sample chamber 24 of the device for thermogravimetric analysis 20. The changing device 7 has a drive 8 by means of which the flange bushings 4.1, 4.2, 4.3, 4.4 can be moved in such a manner that selectively a flange bushing 4.4, 4.2, 4.3, 4.4 lies opposite the opening 6 of the screen 5. Furthermore, on the upper side of the housing 2, a Peltier element 19 is attached. By thermal coupling, the condensation surfaces 10.1, 10.2, 10.3, 10.4 of the flange bushings 4.1, 4.2, 4.3, 4.4 can be cooled, so that their temperature can be kept approximately constant, for example, at 15° C.

The device for thermogravimetric analysis 20 comprises, in the interior of the sample chamber 24, a sample crucible 21 in which a polymer material 23 to be analyzed can be arranged. Via an oven 25, the polymer material can be heated. The outgassing of components is detected as weight loss by a microscale 22. Furthermore, via a gas inlet 26, the sample chamber 24 can be supplied with an inert gas.

FIG. 2 shows a diagrammatic view of the coupling device 1 from below, i.e., from the side facing the sample chamber 24 of a device for thermogravimetric analysis 20. However, the screen 5 is not represented. The flange bushings 4.1, 4.2, 4.3, 4.4 are detached from the coupling device 1 in the figure shown. Therefore, four bores 9.1, 9.2, 9.3, 9.4 are visible, into which the flange bushings 4.1, 4.2, 4.3, 4.4 can be connected detachably. As can be seen in this figure, the changing device 7 is designed as rotating plate, wherein the bores 9.1, 9.2, 9.3, 9.4 are arranged symmetrically towards the margin of the changing device 7. On the margin of the coupling device 1, a threading 3 is arranged, by means of which the coupling device 1 can be connected detachably to a device for thermogravimetric analysis 20.

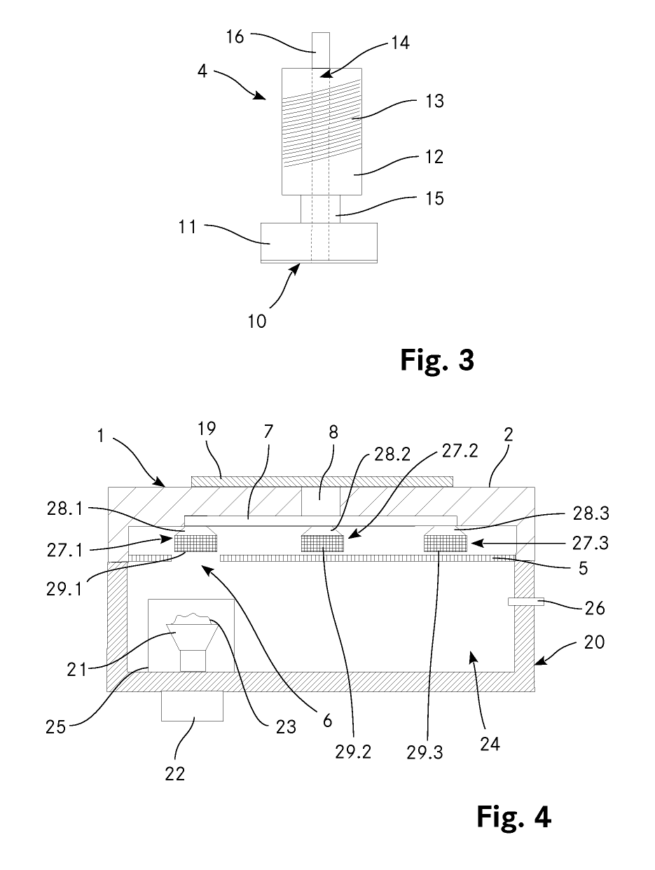

FIG. 3 shows a flange bushing 4 in a detailed side view. On a first end of the flange bushing 4, the condensation surface 10 is arranged. It consists preferably of a polished stainless steel such as stainless steel with material code 1.4301, for example. The flange bushing 4 consists of a cylindrical flange 11 as well as of a cylindrical bushing 12 which are detachably connected to one another. The connection is implemented via a pin 15 which has a threading that engages in a corresponding inner threading of the cylindrical bushing 12. The cylindrical bushing 12 has an outer threading 13 on its lateral surface by means of which the flange bushing 4 can be detachably connected in a bore 9 of the changing unit 7. Furthermore, within the flange bushing 4, a gas passage 14 is arranged, by means of which suctioning can be carried out in the sample chamber 24 of the device for thermogravimetric analysis 20 by means of a pump (not shown). As a result, a gas flow towards the condensation surface 10 is generated, by means of which outgassed components of the polymer material are conveyed in the direction of the condensation surface. For the connection to a pump, the flange bushing 4 has a connection sleeve 16.

FIG. 4 shows the coupling device 1 according to FIG. 1 in a diagrammatic cross section, wherein the coupling device 1 is again connected to a device for thermogravimetric analysis 20.

In contrast to the embodiment according to FIG. 1, in the embodiment shown in FIG. 4, no flange bushings 4.1, 4.2, 4.3 are used, but adsorption elements 27.1, 27.2, 27.3 are used instead. The adsorption elements 27.1, 27.2, 27.3 each include a base 28.1, 28.2, 28.3 which can be connected detachably to the coupling device 1. On each base 28.1, 28.2, 28.3, an adsorption body 29.1, 29.2, 29.3 is fastened, which consists of an adsorbent material. Preferably the adsorbent material comprises activated charcoal.

1. A coupling device for thermogravimetric analysis, comprising:
a) a housing with a connecting element by means of which said housing can be connected in a gas-tight and detachable manner to a sample chamber of a device for gravimetric analysis;
b) at least two flange bushings or at least two adsorption elements which are detachably connected to the coupling device and comprise, on a first side, a condensation surface or an adsorption body for gaseous components;
c) a screen which is arranged such that it lies between the at least two flange bushings or the at least two adsorption elements and the sample chamber, wherein the screen has at least one opening;
d) a changing device which allows the at least two flange bushings, the at least two adsorption elements or the screen to move in such a way that the condensation surface of at least one flange bushing or the adsorption body of at least one adsorption element lies opposite the at least one opening;
e) a cooling device which allows the condensation surfaces of the at least two flange bushings or the adsorption bodies of the at least two adsorption elements to be cooled.

2. The coupling device according to claim 1, wherein the at least two flange bushings have a cylindrical flange arranged on the first end and a cylindrical bushing arranged on the second end opposite the first end, which are detachably connected to one another.

3. The coupling device according to claim 2, wherein the cylindrical bushing has an outer threading by means of which said bushing can be detachably connected in bores of the changing device.

4. The coupling device according to claim 2, wherein the cylindrical bushing is made of copper and the cylindrical flange is made of stainless steel.

5. The coupling device according to claim 1, wherein the at least two adsorption elements comprise a base by means of which the adsorption elements can be detachably connected to the changing device, wherein the adsorption body which comprises an adsorbent material is fastened to the base.

6. The coupling device according to claim 5, wherein the adsorbent material comprises activated charcoal.

7. The coupling device according to claim 1, wherein the cooling device is a Peltier element.

8. The coupling device according to claim 1, wherein the at least two flange bushings or the at least two adsorption elements have a gas passage line by means of which the gas located in the sample chamber can be suctioned.

9. The coupling device according to claim 1, wherein the connecting element is formed as threaded.

10. A method for analyzing a polymer material, comprising the steps:
a) putting the polymer material in a sample crucible of a device for thermogravimetric analysis;
b) connecting a coupling device according to claim 1 to a sample chamber of the device for thermogravimetric analysis;
c) moving the at least two flange bushings, the at least two adsorption elements or the screen by means of the changing device in such a manner that the condensation surface of a first of the at least two flange bushings or the adsorption body of a first of the at least two adsorption elements lies opposite the opening of the screen;
d) heating the sample crucible and moving the at least two flange bushings, the at least two adsorption elements or the screen by means of the changing device in such a manner that, for each outgassed component of the polymer material, the first end of a different flange bushing or an adsorption body of a different adsorption element lies opposite the opening;
e) removing the at least two flange bushings or the at least two adsorption elements from the coupling device;
f) analyzing the components of the polymer material which lie on the condensation surfaces of the at least two flange bushings or in the adsorption bodies of the at least two adsorption elements by means of spectroscopy.

11. The coupling device according to claim 3, wherein the cylindrical bushing is made of copper and the cylindrical flange is made of stainless steel.
